(19) United States
(12) Patent Application Publication
(10) Pub. No.: US 2006/0213881 A1
(43) Pub. Date: Sep. 28, 2006

(54) Laser ablation of doped fluorocarbon materials and applications thereof

(75) Inventors: Arnold Oliphant, Erda, UT (US); Michael McNeely, Sandy, UT (US)

Correspondence Address: MYRIAD GENETICS INC.;INTELLECUTAL PROPERTY DEPARTMENT, 320 WAKARA WAY, SALT LAKE CITY, UT, 84108, US

(73) Assignee: Myriad Genetics, Incorporated, Salt Lake City, UT (US)

(21) Appl. No.: 11/445,536

(22) Filed: Jun. 2, 2006

Related U.S. Application Data
(63) Continuation of application No. 10/009,674, filed on Dec. 6, 2001.
(60) Provisional application No. 60/138,091, filed on Jun. 8, 1999.

(51) Int. Cl. B23K 26/36

(52) U.S. Cl. 219/121.69; 264/400

(57) ABSTRACT

A method for laser ablation of doped fluorocarbon materials, such as fluorocarbon resins, and article fabrication applications using the laser ablation are disclosed. More specifically, a UV absorbing additive, such as carbon black, is compounded with a fluorocarbon resin which is then subjected to laser ablation. The present invention is particularly useful for bulk structure fabrication, for example microstructure micro fabrication.

### CROSS-REFERENCE TO RELATED APPLICATIONS

This application is a continuation of U.S. patent application Ser. No. 10/009,674, filed Dec. 6, 2001; which claims benefit of international patent application Serial No. PCT/US00/40156, filed Jun. 8, 2000; which claims benefit of U.S. provisional application Ser. No. 60/138,091, filed Jun. 8, 1999; each of which are incorporated herein by reference in their entirety.

### BACKGROUND OF THE INVENTION

The present invention is directed to a method for laser ablation of fluorocarbon materials, such as fluorocarbon resins, and to applications for laser ablating such fluorocarbons. The present invention is particularly useful for bulk structure fabrication, e.g., microstructure microfabrication.

The publications and other materials used herein to illuminate the background of the invention, and in particular cases, to provide additional details respecting the practice, are incorporated by reference, and for convenience are numerically referenced in the following text and respectively grouped in the appended bibliography.

Fluorine resins have excellent heat resistance, chemical resistance and electrical characteristics that are rarely obtained from other synthetic resins. Characteristics of fluorocarbon resins can be modified by the inclusion of dopants. For example, U.S. Pat. No. 4,405,544 describes the use of carbon black in Teflon to improve thermal conductance and electrical conductance for use as an electrode. Fluorocarbon polymer-pigment coating compositions have been stabilized against discoloration by doping with a metal oxide or hydroxide to improve color stability (U.S. Pat. No. 4,150,008).

However, because fluorocarbons have an inactive surface, they have poor receptivity to adhesives, coatings or inks and are thus difficult to combine with other materials. It has also been difficult to surface or deep etch these resins. Several techniques for etching fluorocarbons have been developed, and these include ion beam etching et al., 1982), thermally assisted ion beam etching (Berenschot et al., 1996) and alkali metal vapor etching (U.S. Pat. No. 4,855,018).

An additional technique that has been developed for modifying fluorocarbons is laser ablation. For example, vacuum assisted laser ablation using 4th harmonic (266 nm) ND-YAG has been described for redeposition applications, such as coating another surface (Blanchet, 1993). Excimer laser ablation of doped Teflon AF films has been described in which the dopant was tris (perfluoroalkyl) triazine (Hiraoka et al., 1990). However, the method did not work with other thermally processed fluorocarbons. Micromachining of PTFE using radiation generated by a synchrotron (wavelengths: 0.1 nm-180 nm, usually 160 nm) in a vacuum is described in U.S. Pat. No. 5,730,924. A similar process is described in U.S. Pat. No. 5,555,549 for surface modification of fluoropolymers in general. Laser ablation for micromachining of PTFE has also been described using either vacuum ultraviolet lasers whose wavelengths were 160 nm or 157 nm or ultrashort lasers (Kuper et al., 1989); Wada et al., 1993). PTFE resin material containing metal oxide dopants was marked using a laser (U.S. Pat. No. 5,501,827). Surface modification of fluorine resin containing a dopant, such as other fluorocarbons, metal oxides, and carbon family elements, with laser light has been described in U.S. Pat. No. 5,320,789.

High fluence UV lasers have become popular as tools for microfabrication. Their precise control of focused energy has been shown to remove small amounts of material on a substrate that absorbs UV light. The method of removal is photoablation, where atomic and molecular bonds are torn apart when high energy photons are absorbed, causing illuminated material to disassociate from the bulk. A cloud of gaseous debris can be observed above the material as it is illuminated with the laser. This precise control of material removal can allow for the fabrication of complex micro geometries. Laser ablation is not suitable for the removal of large amounts of material, due to very long processing times. It is very different than IR laser processing that is solely a thermal process where material is melted or burned away, leaving a considerable amount of molten debris, and where the control of material removal is limited. Depending on the material some thermal effects may also take place at UV wavelengths.

Many fluorocarbons, such as polytetrafluoroethylene (PTFE or Teflon), and tetrafluoroethylene (TFE) copolymerized with fluorinated ethylenepropylene (FEP), perfluoralkoxy alkane (PFA), and trifluoromethyl difluorodioxolene (Teflon are mostly transparent to UV light of wavelengths greater than 200 nm. This makes them unsuitable for laser ablation because not enough energy is absorbed to break atomic and molecular bonds, although they may reach a high enough temperature that they melt locally. Some of these materials have shown ablation responses in the 157 nm wavelength range, which can be generated using a fluorine-fluorine excimer laser. However this type of laser is not very suitable for industrial use due to the care required to maintain the system and to operate it frequently. More suitable wavelengths for material processing are 222 nm (KrCl), 248 nm (KrF), 308 nm and 351 nm (XeF) for excimer lasers and 266 nm for a quadrupled Nd-YAG laser. These are more suitable due to the longer life of the system optics and the ability to process the material in an ambient atmosphere of air. Thus, there is a need to develop an industrially useful method for laser ablation of fluorocarbon resins, especially for bulk structure fabrication, e.g., microstructure microfabrication.

### BRIEF SUMMARY OF THE INVENTION

The present invention is directed to a method for laser ablation of fluorocarbon materials, such as fluorocarbon resins, and to applications for laser ablating such fluorocarbons. More specifically, a UV absorbing additive is compounded with a fluorocarbon resin, which is then subjected to laser ablation. The laser ablation in accordance with the present invention can be applied to all forms of fluorocarbon resin including, but not limited to, extruded, sintered, or otherwise formed articles, films, tubes or sheets. The laser ablation can be used to surface modify fluorocarbon resins and can also be used for surface or deep etching. The laser ablation of doped fluorocarbons in accordance with the present invention is useful for applications including, but not limited to, changing surface properties and bulk properties to elicit hydrophilic effects, change color, change electrical properties, create fluid channels and wells, and general micromachining of substrate.

### DETAILED DESCRIPTION OF THE INVENTION

Surface modification is a science whose purpose is to alter the natural state of the surface of a material to give it a characteristic more suitable for a specific application.

Surface modification techniques rarely involve altering the characteristics of material deeper than a few hundred atomic layers inside the material. Surface modification is used to physically roughen a material to improve the adhesion of another material that will be deposited on the modified surface. It is used to expose unbound atomic bonds to make them available for covalent attachment to molecules that are introduced onto the material surface.

It is used to clean the material surface and remove loosely bound particles. It can also be used to mark a surface by depositing or removing nanometer deep layers of material, or somehow roughening the surface to expose a visible contrast. It is typically thought of as only altering a material in two dimensions (just the surface, with no depth) Bulk micromachining, on the other hand, is used to generate geometrical physical structures on or in a material. It involves the manipulation of a significant volume of material (relatively speaking) and results in structures that have measurable 3-dimensional cross-sectional profiles. Examples of bulk micromachining are the fabrication of physical barriers to impede the flow of electrons or molecules (fluids), generation of vias to allow electrical connection between layers in a composite material, and mechanical fluid channels, micro gears, or cantilevers.

The present invention is directed to a method for laser ablation of fluorocarbon materials, such as fluorocarbon resins, and to applications for laser ablating such fluorocarbons. More specifically, a UV absorbing additive is compounded with a fluorocarbon resin, which is then subjected to laser ablation. Carbon black is a presently preferred UV absorbing additive. The present invention is particularly useful for bulk structure fabrication, e.g., microstructure microfabrication, which results from the use of dopants and high laser fluence.

The terms “fluorocarbon,” “fluoroplastic,” “fluoropolymer,” “fluorocarbon resin,” or “fluorine resin” as used herein means an organic polymeric material containing fluorine atoms, including, but non-limited to, poly (tetrafluoroethylene) (PTFE), poly (tetrafluoroethylene-co-perfluoroalkoxyethylene) (PFA), poly (tetrafluoroethylene-co-hexafluoropropylene) (FEP), poly (tetrafluoroethylene-co-hexafluoropropylene-co-perfluoroalkoxyethylene) (EPE), poly (tetrafluoroethylene-co-ethylene) (ETFE), poly (PCTFE), poly (chlorotrifluoroethylene-co-ethylene,) (ECTFE), poly (vinylidene fluoride) (PVDF), poly (vinyl fluoride) (PVF) and mixtures comprising two or more of these resins in arbitrary ratios.

The term carbon black is well known in the art. There are many types of carbon black that are distinguished by the method of manufacture, particle size, aggregate size, surface area, color, pH, and impurity content. Carbon black may also be known as graphite, graphite powder, or just carbon, and it includes carbon fiber and graphite fiber.

To facilitate ablation of fluorocarbon materials a UV absorbing additive is compounded with the fluorocarbon. While not being bound by any theory of operation, it is believed that the mechanism of ablation has changed from pure photoablation, to facilitated photoablation, where the UV absorbing material ablates, as one would expect, but it also removes some of the partially molten host material along with it. As a result of this phenomenon, the present invention is particularly well suited for bulk ablation, i.e., bulk structure fabrication.

The UV absorbing additive may be a metal oxide, organic dopant or carbon black.

Known and novel UV absorbing additives may be used. Examples of some possible UV absorbing additives include Green 50, a compound that contains a mixture of cobalt, titanium, nickel and zinc oxides; 328, an ultraviolet light absorber for plastics and coatings sold by Ciba-Geigy; 770, an ultraviolet light absorber for plastics and coatings sold by Ciba-Geigy; and carbon black. There are many different carbon black materials. Having tested several different types of carbon black, all appeared to work, to one degree or another, in accordance with the present invention.

The additive which is presently preferred and which has primarily been investigated is carbon black. The carbon black does not chemically bond with the host plastic, but acts as an interdispersed impurity. The uniformity of dispersion is dependent on the size of the initial carbon particle and the degree of mixing of the additive with the host plastic. Even small amounts of carbon black change the normally milky colored fluorocarbons to black.

The effectiveness of ablation varies depending on the percentage and quality of additive that is compounded with the host material, and the fluence of the laser itself. Small percentages of carbon, such as 0.5 wt. % or less, do not ablate the host material away, but rather, the carbon itself is ablated away, leaving the milky colored host material in place. Materials with higher percentages of additive, such as 10 wt. % or more, are so highly absorbing that the ablation rate drops significantly and only small amounts of material are removed per laser pulse. This allows for more precise control of material removal, and smoother surface finishes, at the expense of low ablation rates. Very high levels of compounding also may adversely affect the material properties of the fluorocarbon. If low fluence levels are used the effect is similar to low amounts of carbon being present, that is the carbon ablates away and leaves uncolored host material behind.

The method of the present invention comprises irradiating laser light on or penetrating into a fluorocarbon resin containing a UV absorbing material. Laser ablation may be performed after molding, extruding, sintering or otherwise forming articles, films, tubes, sheets and the like.

The UV absorbing material is preferably used in an amount from about 0.1 wt. % to about 25 wt. %, preferably from about 0.5 to 15 wt. %, more preferably from about 1 to 10 wt. %, and most preferably about 4 to 6 wt. %. The amount absorbing material used is dependent on the final application as described further herein. Typically, from about 0.1 to 0.5 wt. % carbon black is used in applications in which selective removal of carbon from a fluoroplastic is desired. Typically, higher percentages of carbon black, which results in lower ablation rates, are used for bulk laser ablation to achieve higher quality and better depth control. The preferred percentage of carbon black in this latter application is about 5 wt. %, typically from 4 to 6 wt. %.

The laser light used in the present invention is ultraviolet laser light having a wavelength from about 180 nm to about 400 nm, preferably from about 193 nm to about 355 more preferably from about 248 nm to about 315 nm, and most preferably about 8 nm. A beam diameter of 50 to 250 Rm can be used.

The fluence of the laser light used in the present invention is 0.1 or higher, preferably 0.5 or higher, and more preferably 0.9 or higher.

The laser fluence used is dependent on the amount absorbing material and the final application as described further herein. Typically a low fluence of about 0.1 to about 1 can be used for selective removal of dopant from a fluoroplastic. A higher fluence, typically from about 1 to about 10 can be used for bulk ablation. It is anticipated that higher fluence lasers will be developed in the future; therefore, the present invention is not limited to a maximum fluence.

A rep rate of from about 10 to about 100 hertz or higher, such as up to 300 or 500 hertz, is used. The rep rate of some laser systems can be up to 1000 hertz. The rep rate determines how fast the laser ablation occurs. The translational movement of the laser may be from about 0.1 mm/sec to about 2 mm/sec.

Laser light irradiation is usually out in normal atmosphere at room temperature. If desired, it may also be carried out under reduced pressure or in an oxygen atmosphere and/or under heating or cooling. The conditions of laser light irradiation vary depending on the kind of fluorocarbon resin to be treated, the amount absorbing material utilized and the application for which laser ablation is being applied.

Carbon black is compounded with a fluorocarbon resin using conventional techniques well known to a skilled artisan. For example, fluorocarbon resin powder and carbon powder are dry blended by means of a mixing machine, e.g., a tumbling mixer or a Henschel mixer, and the mixed powder is molded in a mold under a pressure of from about 160 to 500 to obtain a preform. The preform is subjected to sinter molding to form a molded article by a free baking method in which the preform is sintered in a hot air heating furnace at a sintering temperature of from about to a hot molding method in which the preform is sintered in a mold, or a continuous molding method using a ram extruder. In another example, a heat-fusible fluorine resin, such as PFA, and carbon powder are dry blended in a mixing machine, e.g., a tumbling mixer or a Henschel mixer, and the mixture is pelletized by means of an extruder. The mixture may be kneaded by means of, for example, a roll mill or a Banbury mixer and pelletized by means of a sheet pelletizer.

The resulting blend pellets are molded into a rod, tubing, or film by means of an injection molding apparatus or an extruder. Other known processes to obtain molded, extruded, sintered, or otherwise formed articles, films, tubes, sheets and the like may also be used to prepare the material for laser ablation.

The present invention can be exemplified using FEP and carbon black. FEP ethylene propylene) is an injection moldable form of Teflon. In its natural state FEP is milky white in appearance and is fairly transparent to UV light. In order to improve the UV absorption of the material FEP was compounded, with a carbon black additive. The addition of carbon black allows the FEP to absorb more UV radiation so it can be etched using a UV ablation process. The compounded material is coal black, even with very small percentages of carbon loading. The carbon black does not chemically bond with the host plastic, but acts as an interdispersed impurity. The uniformity of dispersion is dependent on the size of the initial carbon particles and the degree of mixing of the additive with the host plastic.

Laser ablation is performed by focusing a UV laser onto the plastic surface. The atomic and molecular bonds within the substrate absorb the laser energy and are excited to breakage. A cloud of gaseous debris is observed above the material as it is illuminated with the laser. This debris can be easily blown or sucked away. This mechanism differs from thermal ablation mechanism, such as with an IR laser, where the material becomes molten and splatters away from the incoming beam. Depending on the material some thermal ablation may take place at UV wavelengths. This thermal ablation is similar to what happens to FEP when no additive is present. Enough energy is absorbed to melt the material, but not enough to ablate it.

With the addition of the carbon black, the mechanism of ablation was assumed to be a combination of both thermal and photo absorption means. The carbon readily absorbs UV light, and as it is ablated it may remove some surrounding molten host material with it.

Carbon black is a common additive in plastics and is used primarily as a pigment, a UV absorber, a reinforcement filler, and as an electrical conductivity enhancer. The effectiveness of carbon black in achieving these desired results depends on the grade of the additive that is used, the percentage of loading, and its quality of dispersion within the host material. A process that selectively removes carbon from a host material in a highly controlled way could be used to control all of these qualities.

There are numerous potential applications of the ability to selectively leach out carbon black from a host material including, but not limited to, the applications described herein. The laser ablation process of the present invention includes the use of molded, sintered, or otherwise formed articles, films, tubes, sheets and the like may also be used to prepare the material for laser ablation.

The present invention can be exemplified using FEP and carbon black. FEP ethylene propylene) is an injection moldable form of Teflon. In its natural state FEP is milky white in appearance and is fairly transparent to UV light. In order to improve the UV absorption of the material FEP was compounded, with a carbon black additive. The addition of carbon black allows the FEP to absorb more UV radiation so it can be etched using a UV ablation process. The compounded material is coal black, even with very small percentages of carbon loading. The carbon black does not chemically bond with the host plastic, but acts as an interdispersed impurity. The uniformity of dispersion is dependent on the size of the initial carbon particles and the degree of mixing of the additive with the host plastic.

Laser ablation is performed by focusing a UV laser onto the plastic surface. The atomic and molecular bonds within the substrate absorb the laser energy and are excited to breakage. A cloud of gaseous debris is observed above the material as it is illuminated with the laser. This debris can be easily blown or sucked away. This mechanism differs from thermal ablation mechanism, such as with an IR laser, where the material becomes molten and splatters away from the incoming beam. Depending on the material some thermal ablation may take place at UV wavelengths. This thermal ablation is similar to what happens to FEP when no additive is present. Enough energy is absorbed to melt the material, but not enough to ablate it.

With the addition of the carbon black, the mechanism of ablation was assumed to be a combination of both thermal and photo absorption means. The carbon readily absorbs UV light, and as it is ablated it may remove some surrounding molten host material with it.

Carbon black is a common additive in plastics and is used primarily as a pigment, a UV absorber, a reinforcement filler, and as an electrical conductivity enhancer. The effectiveness of carbon black in achieving these desired results depends on the grade of the additive that is used, the percentage of loading, and its quality of dispersion within the host material. A process that selectively removes carbon from a host material in a highly controlled way could be used to control all of these qualities.

There are numerous potential applications of the ability to selectively leach out carbon black from a host material including, but not limited to, the applications described herein. The laser ablation process of the present invention includes the use of molded, extended, sintered, or otherwise formed articles, films, tubes, sheet, and the like. The present method is used not for surface modification only, but for surface or deep etching, and the applications include changing surface properties and bulk properties to elicit hydrophilic effects, change color, change electrical properties, create fluid channels and wells, and general micromachining of substrate. The present invention is particularly useful for bulk structure fabrication, e.g., microstructure micro fabrication.

The results of this work demonstrate that fluorocarbon materials, when compounded with UV absorbing additives, can be made processable by laser ablation, especially for bulk micromachining. In addition, the effect and efficiency of ablation can be tuned by adjusting both the percentage of additive in the material and the fluence of the laser beam used to ablate the material.

This process can be used to ablate holes and one, two and three-dimensional structures in bulk fluorocarbon plastics, films, coatings and tubing. Due to the chemical inertness and low surface energy properties of the fluorocarbons, the ability to easily process and form structures in this material has significant benefit. For example, microchannels and wells can be easily etched for microfluidic applications and small holes can be drilled into fluorocarbon tubing to allow non-aqueous phases to be selectively removed.

This process can be used to change the electrical conductivity of the host material. Depending on the percentage of carbon loading a plastic's electrical conductivity can range from that of an insulator, to a semi-conductor, to a conductor. It is conceivable that electrical circuit elements and traces could be fabricated in carbon-loaded fluorocarbons.

Changing the color of a material from black to white would be a straightforward process. It is irreversible and could be used as a visible pattern generation mechanism. This could be done for artistic purposes, or for technical marking where high precision is required. High precision patterns used to test optical elements are an example. Permanent bar-code patterns within a plastic part could also be fabricated. Some optical storage media are also based on variations of optical patterns in a material. It is also possible that a magnetic pattern may result by selectively removing the carbon. Magnetic effects of carbon loaded vs. native material are unknown at this time.

Selectively changing the mechanical properties of a material is also useful. It would be similar to making a composite structure, but with using only one material. This could allow a material to be bent more easily in a particular region, have a controlled breakage site, or have varying surface roughness characteristics. Varying the surface roughness of the material could allow greater adhesion at the site of roughness, and could allow for quasi-hydrophilic behavior.

Since the carbon particles occupy a certain amount of space and have a definite size, removing them from a host plastic may leave the host plastic porous, the pore size being proportional to the size of the carbon particle. This could be used to fabricate filters or semi-permeable membranes.

As previously described different concentrations of dopant and different laser irradiation conditions can be used to achieve different effects useful for these applications.

In those applications relating to marking, changing electrical properties, or changing mechanical properties, low laser fluence, low rep rate and fast translational movement are preferred. Thus, a laser fluence of from about 0. to about 1 a rep rate of about 10 hertz to about 100 hertz, and a laser translational movement of about 0.5 mm/sec to about 2 mm/sec are typically used. For marking or other instances of selective removal of dopant from the fluorocarbon material, a concentration of dopant of 0.5 wt. % or less is typically used.

In those applications relating to bulk ablation, such as microstructure microfabrication, high laser fluence, high rep rate, and slow translational movement of the laser are most preferred. Thus, a laser fluence of from about to about 10 a rep rate of about 100 hertz or higher, and a laser translational movement of about 0.1 mm/sec to about 1 are typically used. In these applications, the concentration of dopant is from about 1 wt. % to about 10 wt. %, typically about 4 to 6 wt. %.

Various fluorocarbon resins were initially tested, including doped and undoped FEP, PFA, and PTFE. Doped samples were primarily FEP compounded with UV absorbing organic compounds, metal oxides, and carbon black additives. Further tests were also performed with FEP material loaded with different percentages of carbon black additives.

The results of these experiments showed that carbon loaded fluoroplastics could exhibit high quality ablation to produce controllable etching with high surface quality at wavelength ranges previously unusable for these applications. The results achieved with these experiments showed quality not previously seen laser ablation in fluoroplastics. The most significant elements of the results seen with the experiments were the high quality finish that can be achieved, and the ablation rates and depth control that are possible. These findings were unexpected in view of prior art suggestions that laser ablation of doped fluoroplastics is only good for surface effects or film removal, i.e., either no penetration into bulk or no control of depth/quality of ablation.

The present invention is described by reference to the following Examples, which are offer by way of illustration and are not intended to limit the invention in any manner. Standard techniques well known in the art or the techniques specifically described below were utilized.

### EXAMPLE 1

### Laser Ablation of Fluorocarbon Resins

Various fluorocarbons resins were initially tested, including doped and undoped FEP, PFA, and PTFE. Doped samples were primarily FEP compounded with organic, metal oxide, and carbon black additives. The conditions of laser irradiation were as follows: beam diameter or 125 or 280 fluence of 1-10 rep rate of 100 hertz, and translational movement of the laser of 0.1-2 mm/sec. The results of these initial studies confirme lack of precision with metal oxides and organic dopants (which were suggested by the prior art as for surface modification applications). However, some control over depth/quality of laser ablation was seen with carbon black dopants at the high fluence tested.

On the basis of these initial studies, further studies were conducted with carbon doped fluorocarbon resins.

### EXAMPLE 2

### Laser Ablation of Carbon Loaded FEP

While attempting to ablate carbon loaded FEP using a KrF laser operating at 248 nm, an interesting phenomenon was noticed. When the percentage of carbon black additive is low (approximately less than 0.5 wt. %) there is not enough carbon present in the material to effectively remove the host plastic. The carbon itself is removed from the material, but little or no host material is removed. The result is a selective removal of carbon that turns the material from its black color to its natural milky white appearance. If the laser is allowed to dwell, the depth of this removal increases, but thermal effects begin to distort the host material as well, causing it to melt and bubble. If the laser pulses once or only a few times in one place it appears as though the material is being ‘bleached’ due to the change in color. For this experiment, the laser energy was approximately 10 mJ and was operating at a fluence of approximately 10 a rep rate of 100 Hz. The pulse width of the KrF laser is approximately 7-10 ns.

FEP of 5 different carbon loadings were ablated. The conditions of laser irradiation were as follows: beam diameter of 165 or 200 fluence of 1-10 rep rate of 100 hertz and translational movement of the laser of 0.1-2 mm/sec. The percentages of loading were 0.01 wt. %, 0.5 wt. wt. %, 5 wt. %, and 10 wt. %. In addition, PFA (another Teflon derivative) of 5 wt. % carbon loading was ablated. The bleaching effect was only observed on the 0.01 wt. % and 0.5 wt. % loaded material. The higher percentage material ablated without an obvious color change.

The bleaching was noticed because of the selective removal of carbon black from FEP. This effect is seen in other fluorocarbon polymers in which the UV absorbing material is miscible in the host material and in which there is a difference in the ablation rate of the host material and the additive.

### EXAMPLE 3

### Further Laser Ablation Studies

In further analysis of the laser ablation of carbon loaded fluorocarbons a second excimer laser was used. This laser operated at 248 but had a shorter pulse width, approximately 3-4 ns. Table 1 shows approximate values of ablation depth per pulse for this KrF laser with an energy of approximately per pulse and a beam diameter of approximately (after a demagnification of 10× from the output of the laser), for fluorocarbons with different percentages of carbon black additive. The carbon black additive was Regal 660 available from the Cabot Corporation Special Blacks Division. The lower ablation rates associated with higher percentages of carbon give greater depth control, however the speed of material removal is reduced and very high carbon loading can adversely affect the mechanical properties of the plastic. The quality of low carbon percentage ablation was very poor, leaving large amounts of bleached plastic “pillars” at the bottom of the resulting depressions.

TABLE 1

| Carbon Loading (wt %) | Depth per pulse (μm) |
|---|---|
| 0.01 | 2.7 |
| 0.5 | 2.0 |
| 1 | 1.5 |
| 5 | 1.3 |
| 10 | 0.92 |

### EXAMPLE 4

### Microfabrication of Microfluidic Structures

Microfluidic structures are structures formed using traditional and adapted bulk microfabrication techniques that are made for the purpose of manipulating small volumes of fluids typically for analysis applications. Fluorocarbon materials are generally hydrophobic in nature. Some microfluidic applications utilize hydrophobic surfaces, either to assist fluid movement control, or to provide for inert surfaces. Microfluidic structures include microchannels, microwells, micro-reaction chambers, micropumps, inlets and outlets, etc. The common element is that they are bulk structures, not surface modified features, and are designed to contain fluid.

For the laser ablation of microfluidic channels, a plate of FEP compounded with 5 wt. % Regal 660 was used as a substrate. The ablation rate was approximately 1 per pulse with a laser energy of 9.5 and pulse width of 3-4 ns. The beam diameter was 300 after a 10× demag through the system optics. A translational speed of 0.2 was used, which generated round bottom channels 300 when the laser operated at 200 Hz.

For reaction chambers or structures larger than one beam diameter, a square aperture was often used, which produces a flat bottom profile. A 5-15% overlap of the ablating beam would produce a structure with minimal bottom surface roughness caused by the overlap. It is important that some overlap exists, so that no wall remains between the beam paths.

It will be appreciated that the methods and compositions of the instant invention can be incorporated in the form of a variety of embodiments, only a few of which are disclosed herein. It will be apparent to the artisan that other embodiments exist and do not depart from the spirit of the invention. Thus, the described embodiments are illustrative and should not be construed as restrictive.

### LIST OF REFERENCES

Berenschot, et al. (1996). Proceedings EEE International MEMS Workshop., pp. 277-284.
Blanchet, G. B. (1993). Phys. Lett. 62:
Garner. C. E. 95:
Hiraoka, H. et al. (1990). Appl. Surf Sci. 46: 342-347.
Kuper et al. (1989). Appl, Phys. Lett. 54: 4.
Wada et al. (1993): Phys. Lett. 62: 211.
U.S. Pat. No. 4,150,008 U.S. Pat. No. 4,405,544 U.S. Pat. No. 4,855,018 U.S. Pat. No. 5,320,789 U.S. Pat. No. 5,501,827 U.S. Pat. No. 5,555,549.
U.S. Pat. No. 5,730,924.

What is claimed is:

1. A method for bulk laser ablation of a fluorocarbon resin comprising irradiating laser light onto or penetrating into a fluorocarbon resin containing an amount from about 0.1 wt. % to about 25 wt. % of UV absorbing material.

2. The method of claim 1, wherein the UV absorbing material is present in the fluorocarbon resin in an amount from about 0.5 wt. % to about 15 wt. %.

3. The method of claim 1, wherein the UV absorbing material is carbon black.

4. The method of claim 1, wherein the wavelength of laser light is from about 180 nm to about 400 nm.

5. The method of claim 1, wherein the fluence of laser light is from about 0.1 J/cm² pulse to about 1 J/cm²/pulse or higher.

6. The method of claim 1, wherein the fluence of laser light is from about 1 J/cm²/pulse to about 10 J/cm²/pulse.

7. The method of claim 1 wherein the wavelength of the laser light is from about 180 nm to about 400 nm and the fluence of the laser light is greater than 0.5 J/cm²/pulse.

8. The method of claim 7, wherein the UV absorbing material is present in an amount from about 0.5 wt. % to about 15 wt. %.

9. The method of claim 7, wherein the UV absorbing material is present in an amount from about 1 to about 10 wt. %.

10. The method of claim 7, wherein the UV absorbing material is present in an amount of about 4 to 6 wt. %.

11. The method of claim 7, wherein the UV absorbing material is carbon black.

12. The method of claim 7, wherein the wavelength of the laser light is from about 193 nm to about 355 nm.

13. The method of claim 7, wherein the wavelength of the laser light is from about 248 nm to about 315 nm.

14. A method of bleaching a substrate comprising the steps:
obtaining a fluorocarbon resin substrate containing carbon black in an amount of from about 0.01 wt. % to 1 wt. %; and
bulk laser ablating the fluorocarbon resin.

15. A method of microfabricating microfluidic structures in fluorocarbon materials comprising the steps:
obtaining a fluorocarbon resin substrate containing a UV absorbing material, said UV absorbing material present in an amount allowing for adequate depth control of material removal during the laser ablation process;
bulk laser ablating the fluorocarbon resin; and
translating the substrate or the laser beam relative to each other to generate microfluidic structures of the desired dimensions.

16. The method of claim 15 where the fluence of the laser light is greater than about 0.1 J/cm²/pulse.

17. The method of claim 15 where the fluence of the laser light is greater than about 1 J/cm²/pulse.

18. The method of claim 15, wherein the UV absorbing material is present in the fluorocarbon resin in an amount from about 0.5 wt. % to about 15 wt %.

19. An article containing geometrical physical structures on or in a material prepared according to the method of claim 1.

20. A microfluidic structure prepared according to the method of claim 15.
